(19) United States
(12) Patent Application Publication
(10) Pub. No.: US 2014/0327842 A1
(43) Pub. Date: Nov. 6, 2014

(54) TOUCH SCREEN AND MANUFACTURING METHOD OF THE SAME

(71) Applicant: SHENZHEN O-FILM TECH CO., LTD., Guangdong (CN)

(72) Inventors: Genchu TANG, Guangdong (CN); Wei LIU, Guangdong (CN); Bin TANG, Guangdong (CN); Shengcai DONG, Guangdong (CN)

(73) Assignee: SHENZHEN O-FILM TECH CO., LTD., Guangdong (CN)

(21) Appl. No.: 14/243,169

(22) Filed: Apr. 2, 2014

(30) Foreign Application Priority Data
May 2, 2013 (CN) 201310159516.6

(51) Int. Cl. G06F 3/041

(52) U.S. Cl. CPC G06F 3/041
USPC 349/12; 156/182

(57) ABSTRACT

A touch screen includes: a transparent substrate, a first substrate layer, a first conductive layer, a first electrode trace; a second substrate layer; a second conductive layer, a second electrode trace, and an insulating layer. The insulating layer is sandwiched between the first substrate layer and the second substrate layer to insulate the first conductive layer and the second conductive layer. The first and second meshed grooves are defined on the first and second substrate layers, the first and second conductive layers with a pre-determined shape can be formed by filling the conductive materials in the first and second meshed grooves. A method of manufacturing the touch screen is also provided.

### FIELD OF THE INVENTION

The present disclosure relates to information exchange technology for electronic devices, and more particularly relates to a touch screen and method of manufacturing of the touch screen.

### BACKGROUND OF THE INVENTION

The touch screen is a sensing device capable of receiving a touch input signal. The touch screen brings a new appearance for information exchange, which is a new appealing information interactive device. In the conventional touch screens, the ITO (indium tin oxide) conductive layer is still an essential part of the touch screen sensing module.

In the conventional process of manufacturing the touch screen, a substrate is firstly coated with ITO on a whole surface thereof, then the ITO is etched to form a plurality of patterned ITO electrodes, and a plurality of transparent electrode traces are finally fabricated and electrically coupled to the ITO electrodes, respectively. Since ITO is an expensive material, when forming the patterned ITO electrode, massive ITO is wasted during an etching process, which will increase the production cost. In addition, the complexity of the etching process will increase the manufacturing process, thereby lowering the production efficiency.

Therefore, there is room for improvement within the art.

### SUMMARY OF THE INVENTION

The present disclosure is directed to a touch screen with a lower cost and a manufacturing method of the touch screen, which has increased production efficiency.

A touch screen includes: a transparent substrate having opposed first and second surfaces; a first substrate layer attached to the first surface, wherein the first substrate layer is made of a transparent insulating material, the first substrate layer defines a first meshed groove on a side thereof away from the transparent substrate; a first conductive layer formed by conductive material filled in the first meshed groove, wherein the first conductive layer is a conductive mesh composed of a plurality of conductive wires intersected with each other; a first electrode trace located on the first substrate layer electrically coupled to the first conductive layer; a second substrate layer located at a side of the first substrate layer away from the transparent substrate, wherein the second substrate layer is made of a transparent insulating material, the second substrate layer defines a second meshed groove on a side thereof facing the first substrate layer; a second conductive layer formed by conductive material filled in the second meshed groove, wherein the second conductive layer is a conductive mesh composed of a plurality of conductive wires intersected with each other; a second electrode trace located on the second substrate layer electrically coupled to the second conductive layer; and an insulating layer sandwiched between the first substrate layer and the second substrate layer to insulate the first conductive layer and the second conductive layer, wherein the insulating layer defines a notch at an end thereof, both free ends of the first electrode trace and the second electrode trace are positioned on both sides of the notch along a thickness direction of the transparent substrate.

A method of manufacturing a touch screen includes the step of

providing a transparent substrate having opposed first and second surfaces;

coating an adhesive on the first surface, curing the adhesive to form a first substrate layer, and defining a first meshed groove on a side of the first substrate layer away from the transparent substrate;

filling conductive material in the first meshed groove to form a first conductive layer; forming a first electrode trace on the first substrate layer, the first electrode trace being electrically coupled to the first conductive layer;

providing a glass cover plate, coating an adhesive on the glass cover plate, curing the adhesive to form a second substrate layer, wherein the second substrate layer defines a second meshed groove on a side thereof away from the glass cover plate;

filling conductive material in the second meshed groove to form a second conductive layer;

forming a second electrode trace on the second substrate layer, the second electrode trace being electrically coupled to the second conductive layer;

providing an insulating layer defining a notch at an end thereof, laminating the transparent substrate and the glass cover plate on opposite sides of the insulating layer, wherein the first conductive layer and the second conductive layer face the insulating layer, and both free ends of the first electrode trace and the second electrode trace are positioned at opposite sides of the notch along a thickness direction of the transparent substrate.

In the touch screen or method described above, since the first and second meshed grooves are defined on the first and second substrate layers, the first and second conductive layers with a pre-determined shape can he formed by tilling the conductive materials in the first and second meshed grooves, no etching process is needed during the manufacturing process, which not only can avoid the waste of raw materials and further reduces the cost of the touch screen, but also can simplify the process and increase the production efficiency.

These and other objects, advantages, purposes and features will become apparent upon review of the following specification in conjunction with the drawings.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a disassembled perspective view of an embodiment of a touch screen;

FIG. 2 is a schematic cross-sectional view of the touch screen of FIG. 1;

FIG. 3 is an assembled perspective view of the touch screen of FIG. 1;

FIG. 4 is an enlarged view of the first conductive layer of the touch screen of FIG. 1;

FIG. 5 is an enlarged view of the second conductive layer of the touch screen of FIG. 1;

FIG. 6 is an enlarged view of the first electrode trace and the second electrode trace according to another embodiment; and

FIG. 7 is a flow chart of an embodiment of a manufacturing method of the touch screen.

### DETAILED DESCRIPTION OF THE EMBODIMENTS

Reference will now be made to the drawings to describe, in detail, embodiments of the present touch screen. It should be noted that references to “an” or “one” embodiment in this disclosure are not necessarily to the same embodiment, and such references mean at least one.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

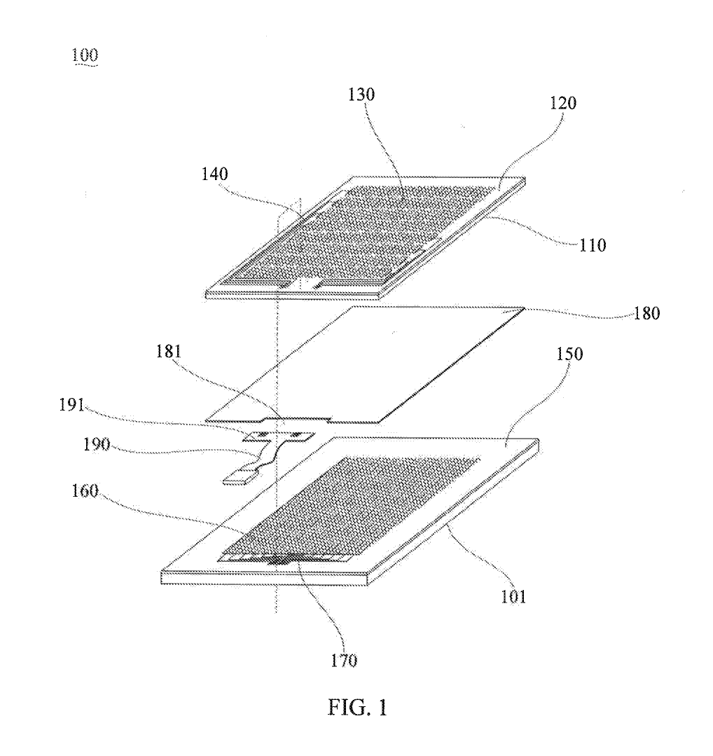

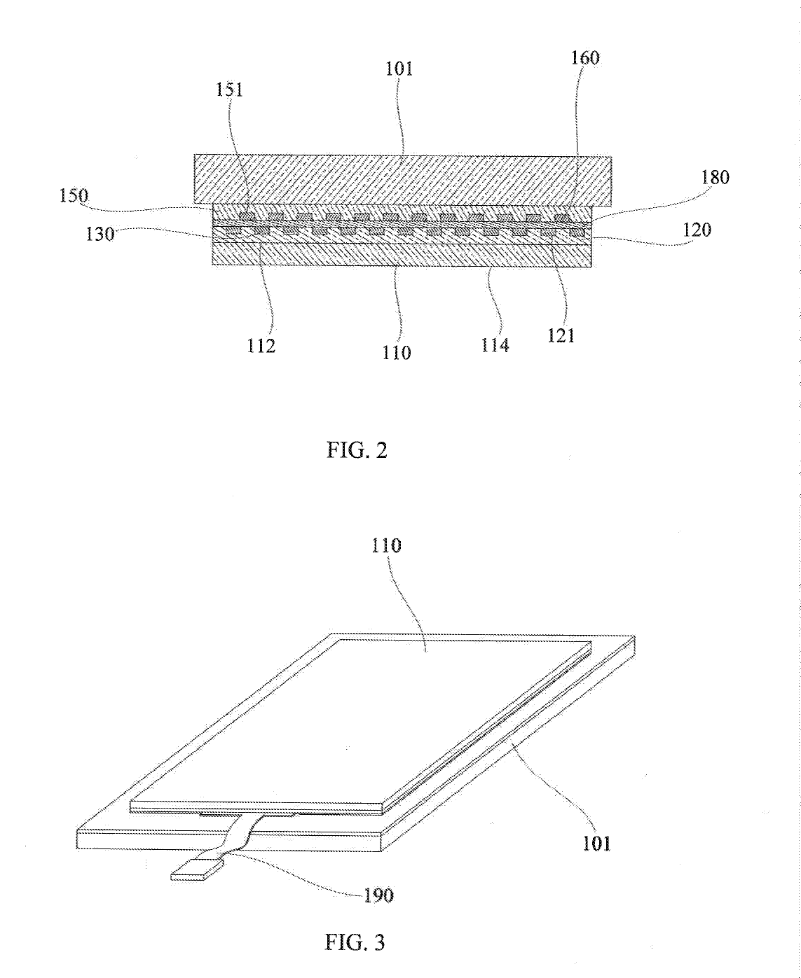

Referring to FIG. 1, FIG. 2, and FIG. 3, an embodiment of a touch screen 100 includes a transparent substrate 110, a first substrate layer 120, a first conductive layer 130, a first electrode trace 140, a second substrate layer 150, a second conductive layer 160, a second electrode trace 170, and an insulating layer 180,

The transparent substrate 110 has a substantially sheet-like structure and includes a first surface 112 and a second surface 114, which are opposite to each other. In the illustrated embodiment, the transparent substrate 110 is made of polyethylene terephthalate (PET). In alternative embodiments, the transparent substrate 110 may be made of other materials, such as polybutylene terephthalate (PBT), polymethyl methacrylate (PMMA), polycarbonate plastic (PC), and glass and the like.

The first substrate layer 120 is attached to the first surface 112. The first substrate layer 120 is made of transparent insulating materials. Specifically, the first substrate layer 120 is formed by curing an adhesive coated on the first surface 112. In addition, the first substrate layer 120 defines a plurality of first meshed grooves 121 on a side thereof away from the transparent substrate 110. The first conductive layer 130 is formed by conductive material filled in the first meshed grooves 121. Furthermore, the first electrode trace 140 is located on the first substrate layer 120, and the first conductive layer 130 is electrically coupled to the first electrode trace 140. Specifically; the first conductive layer 130 has a conductive mesh structure which is composed of a plurality of conductive wires intersected with each other. Therefore, during the preparation process of the touch panel 100, a pre-shape conductive layer can be obtained without etching process, which can avoid waste of the raw material, thereby reducing costs.

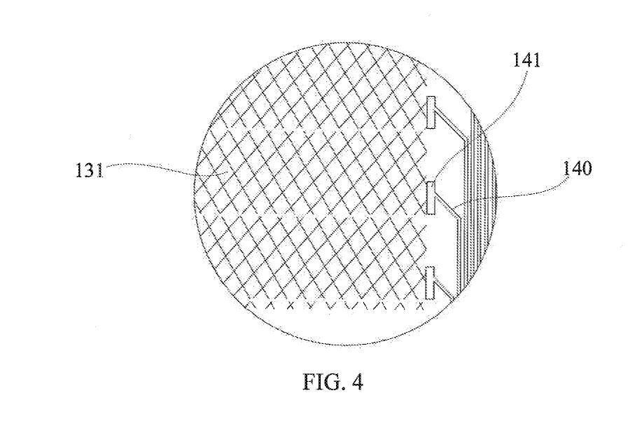

Referring also to FIG. 4, in the illustrated embodiment, the first conductive layer 130 is divided into a plurality of first mesh strips 131 insulated from each other, and the first electrode trace 140 is electrically coupled to the plurality of first mesh strips 131, respectively.

The second substrate layer 150 is located at a side of the first substrate layer 120 away from the transparent substrate 110. The second substrate layer 150 is made of transparent insulating materials. Specifically; the second substrate layer 150 is formed by curing an adhesive. In addition, the second substrate layer 150 defines a plurality of second meshed grooves 151 on a side thereof facing the first substrate layer 120. The second conductive layer 160 is formed by conductive material filled in the second meshed grooves 151. Furthermore, the second electrode trace 170 is located on the second substrate layer 150, and the second conductive layer 160 is electrically coupled to the second electrode trace 170. Specifically, the second conductive layer 160 has a conductive mesh structure which is composed of a plurality of conductive wires intersected with each other.

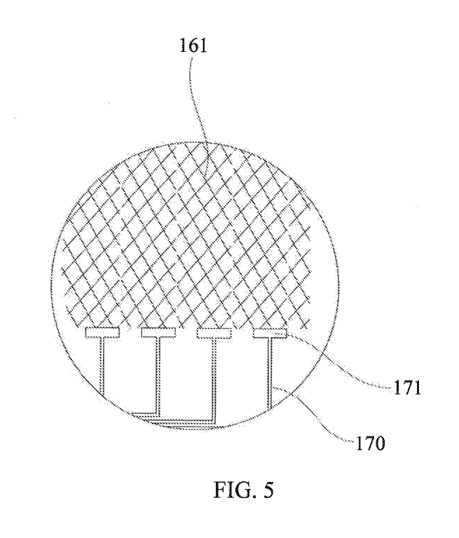

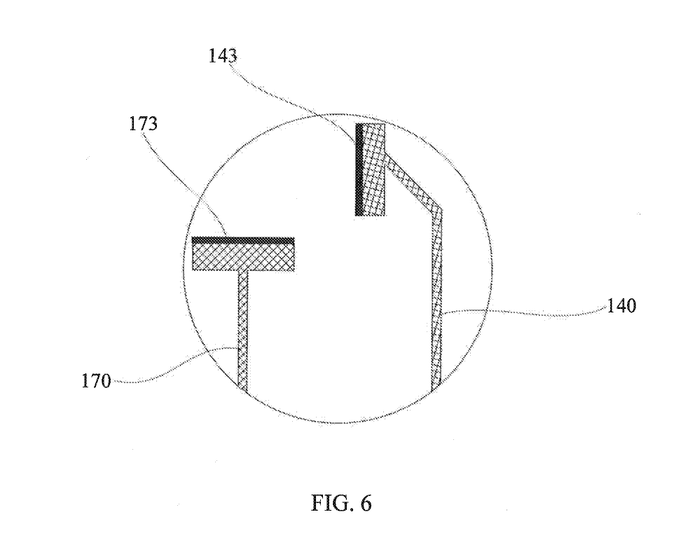

Referring also to FIG. 5, in the illustrated embodiment, the second conductive layer 160 is divided into a plurality of second mesh strips 161 insulated from each other, the second electrode trace 170 is electrically coupled to the plurality of second mesh strips 161.

The conductive meshes of the first conductive layer 130 and the second conductive layer 160 includes a plurality of mesh cells (not labeled), whose shape can be regular or irregular. In the illustrated embodiment, the mesh cell has a shape selected from the group consisting of rectangular, diamond, parallelogram, and curvilinear quadrilateral. In addition, a projection of the mesh cell of the second conductive layer 160 on the first substrate layer 120 is misaligned with the mesh cell of the first conductive layer 130. Specifically, the mesh cell has a regular shape, and the center of the projection of the mesh cell of the second conductive layer 160 on the first substrate layer 120 does not coincide with the center of the mesh cell of the first conductive layer 130, such that the moire stripe can be effectively reduced and a display effect of the touch screen 100 is improved.

Furthermore, in the illustrated embodiment, the conductive material is selected from the group consisting of metal, conductive polymer, graphene, carbon nanotube, and indium tin oxide. The metal is selected from the group consisting of gold, silver, copper, aluminum, nickel, zinc, and alloy thereof.

Referring to FIG. 4 and FIG. 5, in the illustrated embodiment, the first electrode trace 140 and the second electrode trace 170 are both solid wires, which can be embedded in a trench (not labeled) defined on the first Substrate layer 120 and the second substrate layer 150. Using solid wire as the first electrode trace 140 and the second electrode trace 170 can facilitate the fabrication and lower the cost.

Furthermore, in the illustrated embodiment, the first electrode trace 140 is provided with a first connecting portion 141 located at an end thereof adjacent the first conductive layer 130, the first connecting portion 141 is elongated and has a greater width than that of the first electrode trace 140. The second electrode trace 170 is provided with a second connecting portion 171 located at an end thereof adjacent the second conductive layer 160, the second connecting portion 171 is elongated and has a greater width than that of the second electrode trace 170. Specifically, the first electrode trace 140 includes a main body (not labeled), and the first connecting portion 141 is formed by laterally extending an end of the main body close to the first conductive layer 130. The width of the first connecting portion 141 is greater than that of the main body, such that the first connecting portion 141 can be electrically coupled to ends of at least two conductive wires of the first conductive layer 130. Therefore, the connection between the first electrode trace 140 and the first conductive layer 130 can be enhanced, and the disengagement of the first electrode trace 140 and the first conductive layer 130 can be avoided. Similarly, the second connecting portion 171 can enhance the connection between the second electrode trace 170 and the second conductive layer 160,

Referring to FIG. 6, in alternative embodiment, the first electrode trace 140 and the second electrode trace 170 are formed by a plurality of conductive wires intersected with each other, and a side length of a mesh cell of the first electrode trace 140 and the second electrode trace 170 is shorter than a that of a mesh cell of the first conductive layer 130 and the second conductive layer 160. Specifically, the first meshed groove 121 and the second meshed groove 151 includes portions used for forming the first electrode trace 140 and the second electrode trace 170. When the conductive materials are filled in the first meshed groove 121 and the second meshed groove 151, the first electrode trace 140 and the second electrode trace 170 are formed at the same time. This mesh-like structure allows the first electrode trace 140 and the second electrode trace 170 to increase the nodes in the mesh, thus reducing the probability of disconnection of first electrode trace 140 and the second electrode trace 170.

Furthermore, in the illustrated embodiment, the first electrode trace 140 and the second electrode trace 170 are provided with a first electrode adapter cable 143 and a second electrode adapter cable 173, respectively. The first electrode adapter cable 143 and the second electrode adapter cable 173 are both continuous conductive wires.

Since the side length of the mesh cell of the first electrode trace 140 and the second electrode trace 170 is shorter than the side length of the mesh cell of the first conductive layer 130 and the second conductive layer 160, when the first electrode trace 140 and the second electrode trace 170 are electrically coupled to the first conductive layer 130 and the second conductive layer 160 directly, it may be difficult to align with them. In the illustrated embodiment, the first electrode trace 140 and the second electrode trace 170 are electrically coupled to the first conductive layer 130 and the second conductive layer 160 via the first electrode adapter cable 143 and the second electrode adapter cable 173. Since the first electrode adapter cable 143 and the second electrode adapter cable 173 are both continuous conductive wires, the first electrode adapter cable 143 can be connected to ends of at least two conductive wires of the first conductive layer 130 and the first electrode trace 140, and the second electrode adapter cable 173 can be connected to ends of at least two conductive wires of the second conductive layer 160 and the second electrode trace 170. Accordingly, the first electrode adapter cable 143 and the second electrode adapter cable 173 can be used to solve the problem that the metal conductive wires are difficult to be aligned in the mesh having different side lengths of the mesh cell thereof, such that the first electrode trace 140 and the second electrode trace 170 can be well coupled to the first conductive layer 130 and the second conductive layer 160.

The insulating layer 180 is sandwiched between the first substrate layer 120 and the second substrate layer 150 to insulate the first conductive layer 130 and the second conductive layer 160. The first conductive layer 130 and the second conductive layer 160 are located at both sides of the insulating layer 180 face-to-face. The insulating layer 180 defines a notch 181 at an end thereof, and both free ends of the first electrode trace 140 and the second electrode trace 170 are positioned on opposite sides of the notch 181 along a thickness direction of the transparent substrate 110.

When the touch screen 100 is applied to electronic devices such as a mobile phone, the first conductive layer 130 and the second conductive layer 160 are electrically coupled to the same electronic component, such as a controller. In the conventional touch screen, in order to ensure the insulation between the first conductive layer 130 and the second conductive layer 160, the second substrate layer 150 usually defines a groove on a side thereof away from the first conductive layer 130, and the second conductive layer 160 and the second electrode trace 170 are formed in the groove. Accordingly, the first conductive layer 130 and the second conductive layer 160 are arranged back-to-back and are spaced by the second substrate layer 150. When connecting the first conductive layer 130 and the second conductive layer 160, it is necessary to lead the second electrode trace 170 to the same side of the first electrode trace 140 by drilling, threading, etc. However, in the present touch screen 100, since the insulating layer 180 defines the notch 181, and the first conductive layer 130 and the second conductive layer 160 are arranged face-to-face, the free ends of the first electrode trace 140 and the second electrode trace 170 can be leaded to the notch 181. When coupling first conductive layer 130 and the second conductive layer 160 to the same electronic component, they can be electrically coupled to the first electrode trace 140 and the second electrode trace 170 directly through the notch 181, thus simplifying the fabrication of the electronic devices.

In the illustrate embodiment, a thickness of the first conductive layer 130 is less than or equal to a depth of the first meshed groove 121, and a thickness of the second conductive layer 160 is less than or equal to a depth of the second meshed groove 151. Accordingly, the first conductive layer 130 can be covered by the first substrate layer 120, which forms a protection to the first conductive layer 130 and prevents the first conductive layer 130 from being damaged during the subsequent bonding process. Similarly, the second substrate layer 150 can form a protection to the second conductive layer 160.

In the illustrated embodiment, a depth-to-width ratio of the first meshed groove 121 and the second meshed groove 151 is greater than 1, i.e. the depth of the first meshed groove 121 and the second meshed groove 151 is greater than the width thereof. Accordingly, when the conductive materials are filled in the first meshed groove 121 and the second meshed groove 151, the conductive materials may not be easily scratched away, so as to ensure the continuity of conductive mesh.

Referring to FIG. 1 again, the touch screen 100 further includes a printed circuit board 190 and a glass cover plate 101.

The printed circuit board 190 is adapted to be electrically coupled to the free ends of the first electrode trace 140 and the second electrode trace 170, such that the first conductive layer 130 and the second conductive layer 160 can both be connected to the same electronic component. The printed circuit board 190 includes a latching portion 191 having pins (not labeled) located at both sides of the latching portion 191. Since both free ends of the first electrode trace 140 and the second electrode trace 170 are positioned on both sides of the notch 181 along the thickness direction of the transparent substrate 110, when the latching portion 191 is received in the notch 181, the free ends of the first electrode trace 140 and the second electrode trace 170 can be located at both sides of the latching portion 191, so as to facilitate the electrical coupling of the free ends of the first electrode trace 140 and the second electrode trace 170 with the pins of the latching portion 191.

The glass cover plate 101 is attached to a side of the second substrate layer 150 away from the first substrate layer 120. The substrate layer and the conductive layer is relatively soft and easily be damaged, the glass cover plate 101 can provide a protection for them. It should be noted that, in alternative embodiments, the transparent substrate 110 can be made of strengthened glass, which can function both as the support and the protection, therefore the glass cover plate 101 can be omitted.

Since the first and second meshed grooves 121, 151 are defined on the first and second substrate layers 120, 150, the first and second conductive layers 130, 160 with a pre-determined shape can he formed by filling the conductive materials in the first and second meshed grooves 121, 151, no etching process is needed during the manufacturing process, which can effectively avoid the waste of raw materials, thereby reducing the cost of the touch screen 100.

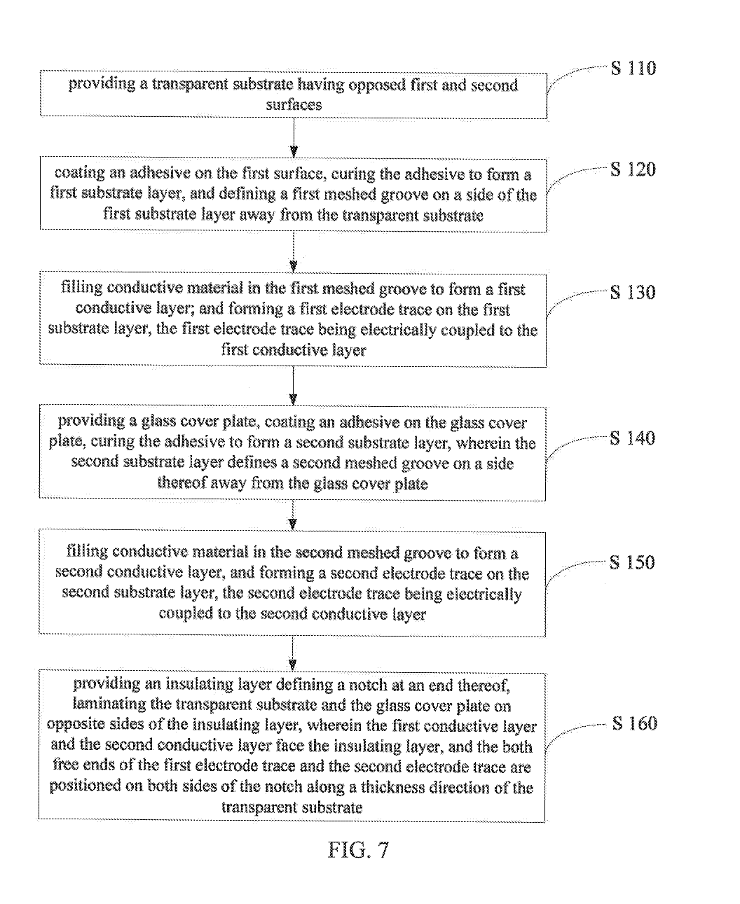

Referring to FIG. 7, an embodiment of a method of manufacturing a touch screen is provided, which includes the following steps:

Step S110, a transparent substrate is provided, which has opposed first and second surfaces.

In the illustrated embodiment, the transparent substrate 110 is made of polyethylene terephthalate (PET). In alternative embodiments, the transparent substrate 110 may made of other materials, such as polybutylene terephthalate (PBT), polymethyl methacrylate (PMMA), polycarbonate plastic (PC), and glass and the like.

Step S120, an adhesive is coated on the first surface, the adhesive is cured to form a first substrate layer, and the first substrate layer defines a first meshed groove on a side thereof away from the transparent substrate by imprinting.

In the illustrated embodiment, a depth-to-width ratio of the first meshed groove is greater than 1. Accordingly, when the conductive materials are filled in the first meshed groove to form the first conductive layer, the conductive, materials may not be easily scratched away, so as to ensure the continuity of conductive mesh.

Step S130, the conductive material is filled in the first meshed groove to form a first conductive, layer; a first electrode trace is formed on the first substrate layer, the first electrode trace is electrically coupled to the first conductive layer.

In the illustrated embodiment, the conductive material filled in the first meshed groove forms a plurality of intersecting metal conductive wires, which forms a conductive mesh. Specifically, the conductive material, such as nanosilver ink, is filled in the first meshed groove by blade coating technique, and the silver in the nanosilver ink is then cured at a temperature of 150° C. to form the metal conductive wire.

Since the first meshed groove is imprinted on the first substrate layer and the first conductive layer with a pre-determined shape is obtained by filling the conductive materials in the first meshed groove, the etching process can be omitted.

Furthermore, solid wires can be formed on the first substrate layer to form the first electrode trace, such that the solid wires can be electrically coupled to the first conductive layer. Moreover, a meshed groove for the first electrode trace can also be defined adjacent to the first meshed groove, such that the first electrode trace can be formed during the same time of forming the first conductive layer by the conductive materials.

Step S140, a glass cover plate is provided, an adhesive is coated on the glass cover plate and cured to form a second substrate layer, the second substrate layer defines a second meshed groove on a side thereof away from the glass cover plate.

Specifically, the second substrate layer is made of the same material as that of the first substrate layer. In the illustrated embodiment, before forming the second substrate layer, the surface of the glass cover plate can be pretreated using plasma beams, which can make the surface of the glass cover plate have a roughness of 5 to 10 nm.

Rough surface is easy for attachment. Therefore, the pretreatment of the surface of the glass cover plate may help the attachment of the adhesive, thereby increasing the bonding of the glass cover plate and a second substrate layer.

Step S150, the conductive material is filled in the second meshed groove to form a second conductive layer, and a second electrode trace is formed on the second substrate layer, the second electrode trace is electrically coupled to the second conductive layer.

Specifically, the conductive material filled in the second meshed groove forms a plurality of intersecting metal conductive wires, which forms a conductive mesh. Specifically, the conductive material, such as nanosilver ink, is filled in the second meshed groove by blade coating technique, and the silver in the nanosilver ink is then cured to form the metal conductive wire.

Furthermore, solid wires can he formed on the second substrate layer to form the second electrode trace, such that the solid wires can be electrically coupled to the second conductive layer. Moreover, a meshed groove for the second electrode trace can also be defined adjacent to the second meshed groove, such that the second electrode trace can be formed during the same time of forming the second conductive layer by the conductive materials.

Step S160, an insulating layer is provided which defines a notch at an end thereof, the transparent substrate and the glass cover plate are laminated on opposite sides of the insulating layer, and the first conductive layer and the second conductive layer face the insulating layer. The both free ends of the first electrode trace and the second electrode trace are positioned on both sides of the notch along a thickness direction of the transparent substrate.

Specifically, the insulating layer is sandwiched between the first and second substrate layers. The first conductive layer and the second conductive layer are face-to-face arranged. The both free ends of the first electrode trace and the second electrode trace are positioned on both sides of the notch along a thickness direction of the transparent substrate, such that the first electrode trace and the second electrode trace can be easily electrically coupled via a double-sided printed circuit board.

In one embodiment, the method of manufacturing a touch screen further includes: providing a printed circuit board, wherein the printed circuit board comprises a latching portion having pins located at both sides thereof, the latching portion is received in the notch, and the free ends of the first electrode trace and the second electrode trace are electrically coupled to the pins of the latching portion. The printed circuit board is electrically coupled to the free ends of the first electrode trace and the second electrode trace, such that the first conductive layer and the second conductive layer can both be connected to the same electronic component.

In the forgoing manufacture method, since the first and second meshed grooves are defined on the first and second substrate layers, the first and second conductive layers with pre-determined shape can be formed by filling the conductive materials in the first and second meshed grooves, no etching process is needed during the manufacturing process, which can simplify the process and increase the production efficiency.

Although the present invention has been described with reference to the embodiments thereof and the best modes for carrying out the present invention, it is apparent to those skilled in the art that a variety of modifications and changes may be made without departing from the scope of the present invention, which is intended to be defined by the appended claims.

What is claimed is:

1. A touch screen, comprising:
a transparent substrate having opposed first and second surfaces;
a first substrate layer attached to the first surface, wherein the first substrate layer is made of a transparent insulating material, the first substrate layer defines a first meshed groove on a side thereof away from the transparent substrate;
a first conductive layer formed by conductive material filled in the first meshed groove, wherein the first conductive layer is a conductive mesh composed of a plurality of conductive wires intersected with each other;
a first electrode trace located on the first substrate layer electrically coupled to the first conductive layer;
a second substrate layer located at a side of the first substrate layer away from the transparent substrate, wherein the second substrate layer is made of a transparent insulating material, the second substrate layer defines a second meshed groove on a side thereof facing the first substrate layer;
a second conductive layer formed by conductive material filled in the second meshed groove, wherein the second conductive layer is a conductive mesh composed of a plurality of conductive wires intersected with each other;
a second electrode trace located on the second substrate layer electrically coupled to the second conductive layer; and
an insulating layer sandwiched between the first substrate layer and the second substrate layer to insulate the first conductive layer and the second conductive layer, wherein the insulating layer defines a notch at an end thereof, both free ends of the first electrode trace and the second electrode trace are positioned on opposite sides of the notch along a thickness direction of the transparent substrate.

2. The touch screen according to claim 1, wherein a thickness of the first conductive layer is less than or equal to a depth of the first meshed groove; a thickness of the second conductive layer is less than or equal to a depth of the second meshed groove.

3. The touch screen according to claim 1, wherein a depth-to-width ratio of the first meshed groove and the second meshed groove is greater than 1.

4. The touch screen according to claim 1, wherein the conductive material is selected from the group consisting of metal, conductive polymer, graphene, carbon nanotube, and indium tin oxide.

5. The touch screen according to claim 4, wherein the metal is selected from the group consisting of gold, silver, copper, aluminum, nickel, zinc, and alloy thereof.

6. The touch screen according to claim 1, wherein the conductive mesh of the first conductive layer and the second conductive layer comprises a plurality of mesh cells, the mesh cell has a shape selected from the group consisting of rectangular, diamond, parallelogram, and curvilinear quadrilateral; a projection of the conductive mesh of the second conductive layer on the first substrate layer is misaligned with the conductive mesh of the first conductive layer.

7. The touch screen according to claim 1, wherein the first electrode trace and the second electrode trace are both solid wires.

8. The touch screen according to claim 7, wherein the first electrode trace is provided with a first connecting portion located at an end thereof adjacent the first conductive layer, the first connecting portion is elongated and has a greater width than that of the first electrode trace, the first connecting portion is electrically coupled to ends of at least two conductive wires of the first conductive layer; the second electrode trace is provided with a second connecting portion located at an end thereof adjacent the second conductive layer, the second connecting portion is elongated and has a greater width than that of the second electrode trace, the second connecting portion is electrically coupled to ends of at least two conductive wires of the second conductive layer.

9. The touch screen according to claim 1, wherein the first electrode trace and the second electrode trace have mesh-like structure and are formed by a plurality of conductive wires intersected with each other; a side length of a mesh cell of the first electrode trace and the second electrode trace is less than a side length of a mesh cell of the first conductive layer and the second conductive layer.

10. The touch,screen according to claim 9, wherein the first electrode trace and the first conductive layer are provided with a first electrode adapter cable therebetween; the second electrode trace and the second conductive layer are provided with a second electrode adapter cable therebetween; the first electrode adapter cable and the second electrode adapter cable are both continuous conductive wires; the first electrode adapter cable is connected to ends of at least two conductive wires of the first conductive layer and the first electrode trace; the second electrode adapter cable is connected to ends of at least two conductive wires of the second conductive layer and the second electrode trace.

11. The touch screen according to claim 1, wherein the first conductive layer is divided into a plurality of insulating first mesh strips; the second conductive layer is divided into a plurality of insulating second mesh strips; the first electrode trace is electrically coupled to the plurality of first mesh strips; the second electrode trace is electrically coupled to the plurality of second mesh strips.

12. The touch screen according to claim 1, further comprising a printed circuit board, wherein the printed circuit board comprises a latching portion having pins located at both sides thereof, the latching portion is received in the notch, and the free ends of the first electrode trace and the second electrode trace are electrically coupled to the pins of the latching portion.

13. The touch screen according to claim 1, further comprising a glass cover plate attached to a side of the second substrate layer away from the first substrate layer.

14. A method of manufacturing a touch screen, comprising the step of:
providing a transparent substrate having opposed first and second surfaces;
coating an adhesive on the first surface, curing the adhesive to form a first substrate layer, and defining a first meshed groove on a side of the first substrate layer away from the transparent substrate;
filling conductive material in the first meshed groove to form a first conductive layer; and
forming a first electrode trace on the first substrate layer, the first electrode trace being electrically coupled to the first conductive layer;
providing a glass cover plate, coating an adhesive on the glass cover plate, curing the adhesive to form a second substrate layer, wherein the second substrate layer defines a second meshed groove on a side thereof away from the glass cover plate;
filling conductive material in the second meshed groove to form a second conductive layer, and forming a second electrode trace on the second substrate layer, the second electrode trace being electrically coupled to the second conductive layer; and
providing an insulating layer defining a notch at an end thereof, laminating the transparent substrate and the glass cover plate on opposite sides of the insulating layer, wherein the first conductive layer and the second conductive layer face the insulating layer, and the both free ends of the first electrode trace and the second electrode trace are positioned at opposite sides of the notch along a thickness direction of the transparent substrate.

15. The method according to claim 14, further comprising:
providing a printed circuit board, wherein the printed circuit board comprises a latching portion having pins located at both sides thereof, the latching portion is received in the notch, and the free ends of the first electrode trace and the second electrode trace are electrically coupled to the pins of the latching portion.
